(19) United States
(12) Patent Application Publication
(10) Pub. No.: US 2026/0167553 A1
(43) Pub. Date: Jun. 18, 2026

(54) RESERVOIR, METHOD FOR PRODUCING OPTICAL FIBER, AND DEVICE FOR PRODUCING OPTICAL FIBER

(71) Applicant: SUMITOMO ELECTRIC INDUSTRIES, LTD., Osaka-shi, Osaka (JP)

(72) Inventors: Shin SATO, Osaka-shi, Osaka (JP); Takemi HASEGAWA, Osaka-shi, Osaka (JP); Hirotaka SAKUMA, Osaka-shi, Osaka (JP)

(21) Appl. No.: 18/724,664

(22) PCT Filed: May 17, 2024
(86) PCT No.: PCT/JP2024/018367

§ 371 Date: Jun. 27, 2024

(30) Foreign Application Priority Data
Jun. 6, 2023 (JP) 2023-092938

(51) Int. Cl. C03B 37/018

(52) U.S. Cl. CPC C03B 37/01892; C03B 37/01876; C03B 2201/12; C03B 2201/50; C03B 2201/54

(57) ABSTRACT

A reservoir is used in producing an optical fiber preform. A raw material containing an alkali metal element or an alkaline-earth metal element is installed in the reservoir when adding the alkali metal element or the alkaline-earth metal element to a glass pipe formed from silica-based glass by thermal diffusion. The reservoir is formed from silica-based glass in which sum of a fluorine concentration and a chlorine concentration is from 1500 ppm to 20000 ppm.

### TECHNICAL FIELD

The present disclosure relates to a reservoir, a method for producing an optical fiber, and a device for producing the optical fiber.

This application claims priority from Japanese Patent Application No. 2023-092938 filed on Jun. 6, 2023, the entire contents of which are incorporated herein by reference.

### BACKGROUND ART

When a core formed from silica-based glass contains an alkali metal element or an alkaline-earth metal element, viscosity is reduced, and thus a network structure of glass is likely to be organized even when a cooling rate is fast during drawing. That is, the number of rings in the ring structure in the network structure of the glass is likely to be uniform. Accordingly, Rayleigh scattering that accounts for most of transmission loss of the optical fiber is reduced. As a result, the transmission loss of the optical fiber can be reduced.

Patent Literature 1 and Patent Literature 2 describe a method of adding the alkali metal element and the alkaline-earth metal element to a glass pipe by a thermal diffusion method. In the thermal diffusion method, a raw material is heated to be evaporated at a raw material installation portion, and the glass pipe is heated by a burner while flowing a raw material vapor into the glass pipe by a carrier gas. According to this, the alkali metal element and the alkaline-earth metal element are diffused and added to the glass pipe. The raw material installation portion is referred to as a “reservoir”. Typically, the reservoir is formed in a saucer shape so as to prevent the raw material from being scattered into the glass pipe by the carrier gas.

In addition, Patent Literature 2 discloses that it is preferable that the glass pipe and the glass attached to an inner side of the glass pipe essentially do not contain chlorine in order to prevent crystallization of the alkali metal.

### CITATION LIST

### Patent Literature

Patent Literature 1: U.S. Patent Application Publication No. 2006/0130530
Patent Literature 2: U.S. Patent Application Publication No. 2022/0283363

### SUMMARY OF INVENTION

A reservoir according to an aspect of the present disclosure is a reservoir which is used in producing an optical fiber preform, and in which a raw material containing an alkali metal element or an alkaline-earth metal element is installed when adding the alkali metal element or the alkaline-earth metal element to a glass pipe formed from silica-based glass by thermal diffusion. The reservoir is formed from silica-based glass in which sum of a fluorine concentration and a chlorine concentration is from 1500 ppm to 20000 ppm.

### BRIEF DESCRIPTION OF DRAWINGS

FIG. 1 is a flowchart illustrating an optical fiber producing method according to an embodiment.

FIG. 2 is a view describing an addition process using an optical fiber producing device according to this embodiment.

FIG. 3 is a view describing an addition process using an optical fiber producing device according to a modification example.

FIG. 4 is a graph illustrating a variation in a concentration distribution of fluorine in accordance with heating when forming a reservoir.

FIG. 5 is a graph illustrating a relationship between a halogen concentration and a defective rate of the reservoir.

FIG. 6 is a graph illustrating a relationship between a chlorine concentration and the defective rate of the reservoir.

### DESCRIPTION OF EMBODIMENTS

### Problems to be Solved by Present Disclosure

In a case where a reservoir is formed from glass with a high chlorine concentration, in the reservoir, the chlorine reacts with an alkali metal element and an alkaline-earth metal element and is crystallized. When the crystal is scattered as a fine powder into a glass pipe, the fine powder acts as a nucleus to cause crystallization of silica glass to occur even in the glass pipe. As a result, there is a concern that a core material for an optical fiber preform becomes defective, and a yield ratio of an optical fiber deteriorates. On the other hand, in a case where the chlorine concentration is excessively low, there is a concern that shape control of the reservoir becomes difficult or the reservoir may be cracked during manufacturing of the reservoir or diffusion addition using the reservoir.

An object of the present disclosure is to provide a reservoir, a method for producing an optical fiber, and a device for producing the optical fiber which are capable of improving a yield ratio of the optical fiber and processability of the reservoir, and are capable of reducing cracking of the reservoir.

### Effects of Present Disclosure

According to the present disclosure, there are provided a reservoir, a method for producing an optical fiber, and a device for producing the optical fiber which are capable of improving a yield ratio of the optical fiber and processability of the reservoir, and are capable of reducing cracking of the reservoir.

### Description of Embodiment of Present Disclosure

First, the contents of an embodiment of the present disclosure will be listed and described.

(1) A reservoir according to an aspect of the present disclosure is used in producing of an optical fiber preform and in which a raw material containing an alkali metal element or an alkaline-earth metal element is installed when adding the alkali metal element or the alkaline-earth metal element to a glass pipe formed from silica-based glass by thermal diffusion. The reservoir is formed from silica-based glass in which sum of a fluorine concentration and a chlorine concentration is from 1500 ppm to 20000 ppm.

In the reservoir, the yield ratio of the optical fiber and the processability of the reservoir can be improved. In addition, cracking of the reservoir can be reduced.

(2) In (1), the reservoir may be formed from silica-based glass in which the sum of the fluorine concentration and the chlorine concentration is from 3500 ppm to 18000 ppm. In this case, the yield ratio of the optical fiber and the processability of the reservoir can be further improved. In addition, cracking of the reservoir can be further reduced.

(3) In (1), the reservoir may be formed from silica-based glass in which the sum of the fluorine concentration and the chlorine concentration is from 3500 ppm to 13000 ppm. In this case, the yield ratio of the optical fiber and the processability of the reservoir can be further improved. In addition, cracking of the reservoir can be further reduced.

(4) In any one of (1) to (3), the reservoir may be formed from silica-based glass in which the chlorine concentration is 20 ppm or more. In this case, cracking of the reservoir can be further reduced.

(5) In any one of (1) to (3), the reservoir may be formed from silica-based glass in which the chlorine concentration is 50 ppm or more. In this case, cracking of the reservoir can be further reduced.

(6) In the (1) or (5), the reservoir may include a connecting end that is separate from the glass pipe, and is fused and connected to the glass pipe. In this case, the reservoir can be removed from the glass pipe, and can be fused and connected to another glass pipe again.

(7) A method for producing an optical fiber according to another aspect of the present disclosure includes adding an alkali metal element or an alkaline-earth metal element to an inner surface of a glass pipe formed from a silica-based glass by using the reservoir according to any one of (1) to (6).

In this case, since the reservoir is used, the yield ratio of the optical fiber and the processability of the reservoir can be improved. In addition, cracking of the reservoir can be reduced.

(8) A device for producing the optical fiber according to still another aspect of the present disclosure includes the reservoir according to any one of (1) to (6) which is connected to the glass pipe, and a heat source configured to heat the reservoir. An alkali metal element or an alkaline-earth metal element is added to an inner surface of the glass pipe.

In this case, since the optical fiber producing device includes the reservoir, the yield ratio of the optical fiber and the processability of the reservoir can be improved. In addition, cracking of the reservoir can be reduced.

### Details of Embodiment of Present Disclosure

Specific examples of the reservoir and the method for producing the optical fiber according to this embodiment will be described with reference to the accompanying drawings as necessary. Note that, the present disclosure is represented by the appended claims without limitation to the exemplification, and is intended to include meanings equivalent to the appended claims and all modifications in the scope. In the following description, the same reference numeral will be given to the same elements in description of the drawings, and redundant description will be omitted.

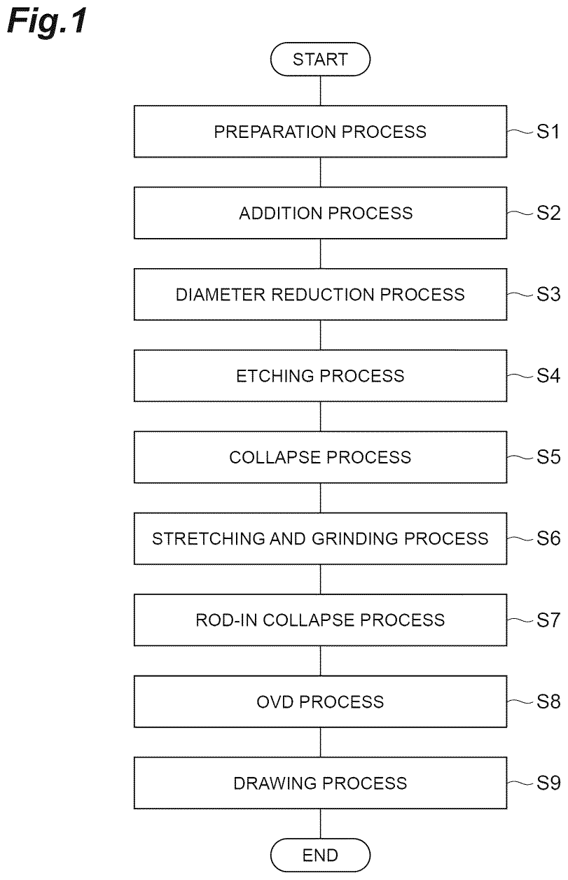

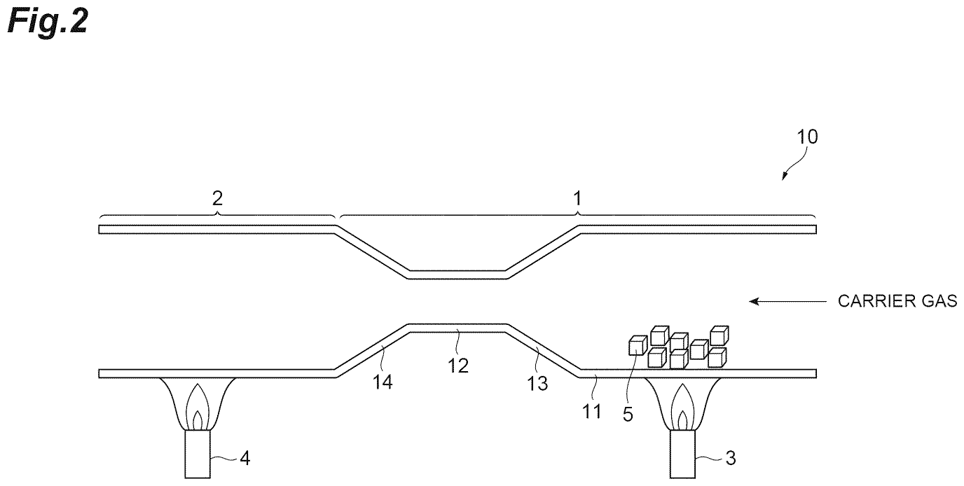

FIG. 1 is a flowchart illustrating the optical fiber producing method according to an embodiment. The optical fiber producing method includes a preparation process S1, an addition process S2, a diameter reduction process S3, an etching process S4, a collapse process S5, a stretching and grinding process S6, a rod-in collapse process S7, an outside vapor deposition (OVD) process S8, and a drawing process S9. The optical fiber is manufactured sequentially from process S1 to process S9. The optical fiber producing method is executed by using an optical fiber producing device 10 (refer to FIG. 2).

Preparation process S1 is a process of preparing a glass pipe into which an alkali metal group as a dopant is to be diffused. Here, the alkali metal group is a general term for an alkali metal element and an alkaline-earth metal element. The glass pipe is formed from silica (quartz)-based glass. The silica-based glass contains 90% or more of silica as a main component. The silica-based glass may contain 95% or more of silica. A silica-based glass rod that is the base of the glass pipe is manufactured, for example, by a vapor phase axial deposition (VAD) method. A pipe is manufactured by perforating and stretching a cylindrical body. The silica-based glass rod that is the base of the glass pipe contains chlorine and fluorine in a certain concentration. A mass fraction of other dopants and impurities is 10 ppm or less. Here, the mass fraction is a ratio of a mass of a target element to a total mass, and represents (the mass of the target element)/(the total mass). In the following description, the mass fraction is referred to as “concentration”.

Addition process S2 is a process of adding the alkali metal group to an inner surface of glass pipe 2 formed from silica-based glass (refer to FIG. 2) by a diffusion method. In a case of adding a potassium (K) element as a dopant of the alkali metal group, for example, potassium bromide (KBr) is used as raw material 5 containing the alkali metal group (refer to FIG. 2). One or a plurality of materials among KBr, potassium iodide (KI), rubidium bromide (RbBr), rubidium iodide (RbI), and the like may be used as raw material 5 depending on the kind of the alkali metal group to be added.

Diameter reduction process S3 is a process of reducing a diameter of the glass pipe to which the alkali metal group is added. Etching process S4 is a process of etching the inner surface of the glass pipe. According to etching process S4, it is possible to scrap the inner surface of the glass pipe which contains a high concentration of impurities added in combination with the alkali metal group, and it is possible to remove the impurities. Collapse process S5 is a process of solidifying the glass pipe to form a glass rod.

Stretching and grinding process S6 is a process of stretching the glass rod and grinding an outer peripheral portion of the glass rod to form a core rod that becomes a core portion. Rod-in collapse process S7 is a process of providing a first cladding portion on an outer side of the core portion. OVD process S8 is a process of stretching the rod obtained by integrating the core portion and the first cladding portion to have a predetermined diameter, and synthesizing a second cladding portion containing fluorine on an outer side of the rod by the OVD method. According to this, an optical fiber preform is manufactured. Drawing process S9 is a process of drawing the optical fiber preform. According to this, an optical fiber is manufactured.

FIG. 2 is a view illustrating the addition process using the optical fiber producing device according to the embodiment. Optical fiber producing device 10 according to the embodiment includes a reservoir 1, a heat source 3, and a heat source 4. Optical fiber producing device 10 is used in producing of an optical fiber, specifically, in addition process S2. That is, reservoir 1 according to the embodiment is used in producing an optical fiber, specifically, in addition process S2. Reservoir 1 is formed from silica-based glass, and contains fluorine and chlorine. The silica-based glass contains 90% or more of silica as a main component. The silica-based glass may contain 95% or more of silica. The silica-based glass rod that is the base of the glass pipe of reservoir 1 is manufactured, for example, by a vapor phase axial deposition (VAD) method. Reservoir 1 is manufactured by perforating and stretching the cylindrical body. The sum of a fluorine concentration and a chlorine concentration in reservoir 1 is from 1500 ppm to 20000 ppm. According to this, a yield ratio of the optical fiber and processability of reservoir 1 can be improved. In addition, cracking of reservoir 1 can be reduced. The sum of the fluorine concentration and the chlorine concentration in reservoir 1 may be from 3500 ppm to 18000 ppm, or from 3500 ppm to 13000 ppm. The chlorine concentration in reservoir 1 is 20 ppm or more. According to this, the cracking of reservoir 1 can be further reduced. The chlorine concentration in reservoir 1 may be 50 ppm or more.

As described above, in a case where reservoir 1 is formed from glass with high chlorine concentration, in reservoir 1, chlorine reacts with the alkali metal element and the alkaline-earth metal element and is crystallized. When the crystal is scattered as a fine powder into glass pipe 2, the fine powder acts as a nucleus to cause crystallization of silica glass to occur even in glass pipe 2. As a result, there is a concern that a core material for an optical fiber preform becomes defective, and a yield ratio of an optical fiber deteriorates. Since the sum of the fluorine concentration and the chlorine concentration in reservoir 1 may be 20000 ppm or less, 18000 ppm or less, or 13000 ppm or less, the yield ratio of the optical fiber can be improved.

In general, a glass material with low chlorine concentration is manufactured by not sufficiently removing impurities by a chlorine gas, or by performing substitution between chlorine and fluorine with a fluorine-based gas. In an optical fiber manufactured by using a reservoir formed from the former glass material, a transmission loss due to an absorption loss caused by impurities deteriorates. Since the latter glass material contains a lot of fluorine, fluorine on a surface is desorbed due to heating during shaping of the reservoir. When fluorine is excessively desorbed, viscosity increases only on the surface, and a tensile stress occurs. According to this, cracks occur on the surface, and the reservoir is likely to be cracked during producing of the reservoir or diffusion addition. In a case where the reservoir is cracked during the diffusion addition, there is a concern that a yield ratio of a core material for an optical fiber preform may deteriorate, and the yield ratio of the optical fiber may deteriorate.

Since the sum of the fluorine concentration and the chlorine concentration in reservoir 1 may be 1500 ppm or more or 3500 ppm or more, the deterioration of the transmission loss of the optical fiber due to insufficient removal of impurities with the chlorine gas is reduced. In addition, occurrence of cracks on the surface due to desorption of a halogen element is reduced. Accordingly, cracking of reservoir 1 is reduced. As a result, the deterioration of the yield ratio of the optical fiber is reduced.

Reservoir 1 is a glass pipe that is connected to glass pipe 2 to which the alkali metal group is added. Reservoir 1 includes a large-diameter portion 11, a small-diameter portion 12, a first connecting portion 13, and a second connecting portion 14. Reservoir 1 functions as an installation portion where raw material 5 containing the alkali metal group is installed when adding the alkali metal group to glass pipe 2 by thermal diffusion. In reservoir 1, raw material 5 is installed mainly in large-diameter portion 11. An outer diameter of large-diameter portion 11 is equal to an outer diameter of glass pipe 2. The small-diameter portion 12 is disposed between first connecting portion 13 and second connecting portion 14. An outer diameter of small-diameter portion 12 is smaller than the outer diameter of glass pipe 2 and is smaller than the outer diameter of the large-diameter portion 11.

First connecting portion 13 connects large-diameter portion 11 and a first end of small-diameter portion 12. As described above, since the outer diameter of small-diameter portion 12 is smaller than the outer diameter of large-diameter portion 11, first connecting portion 13 forms a stepped portion. A height of the stepped portion by first connecting portion 13 is, for example, approximately 1 mm. First connecting portion 13 has a tapered shape. The outer diameter of first connecting portion 13 gradually decreases as going from large-diameter portion 11 to small-diameter portion 12.

Second connecting portion 14 connects a second end of small-diameter portion 12 and glass pipe 2. As described above, since the outer diameter of small-diameter portion 12 is smaller than the outer diameter of glass pipe 2, second connecting portion 14 forms a stepped portion. A height of the stepped portion by second connecting portion 14 is equal to the height of the stepped portion by first connecting portion 13. The outer diameter of second connecting portion 14 has a tapered shape. The outer diameter of second connecting portion 14 gradually decreases as going from glass pipe 2 to small-diameter portion 12.

In this embodiment, reservoir 1 and glass pipe 2 are constituted as one member, and have the same composition prior to addition process S2. Reservoir 1 and glass pipe 2 are formed from, for example, one glass pipe. In the one glass pipe, a portion that becomes small-diameter portion 12 is heated to reduce a diameter. According to this, reservoir 1 and glass pipe 2 are formed in a connected state.

Heat source 3 is disposed on an outer side of reservoir 1. Heat source 3 is an external heat source configured to heat reservoir 1. More specifically, heat source 3 is an external heat source configured to heat raw material 5 installed in reservoir 1. Heat source 4 is disposed on an outer side of glass pipe 2. Heat source 4 is an external heat source configured to heat glass pipe 2. Heat source 3 and heat source 4 are, for example, an oxyhydrogen burner. Heat source 3 and heat source 4 may be induction furnaces, resistive furnaces, or the like.

In addition process S2, raw material 5 is heated by heat source 3 to generate a raw material vapor. A heating temperature is, for example, a temperature from 600° C. to 1000° C. Glass pipe 2 is heated by heat source 4 from the outer side while flowing the generated raw material vapor to the inside of glass pipe 2 in combination with a carrier gas. The carrier gas includes, for example, oxygen. A flow rate of the carrier gas is set to from 1 SLM (volume in a standard state (25° C., 100 kPa) of a flowing-in gas per one minute) to 3 SLM. In reservoir 1, since first connecting portion 13 that forms a stepped portion on a side of large-diameter portion 11 close to glass pipe 2 exists, scattering of raw material 5 into glass pipe 2 due to the carrier gas is reduced.

In addition process S2, heat source 4 is moved along a longitudinal direction of glass pipe 2 to heat glass pipe 2. Heating of glass pipe 2 is performed by traversing heat source 4 at a speed of from 30 mm/min to 60 mm/min for a total of from 8 turns to 15 turns so that a temperature of an outer surface of glass pipe 2 becomes from 1400° C. to 2000° C. According to this, the alkali metal group is diffused and added to an inner surface of glass pipe 2.

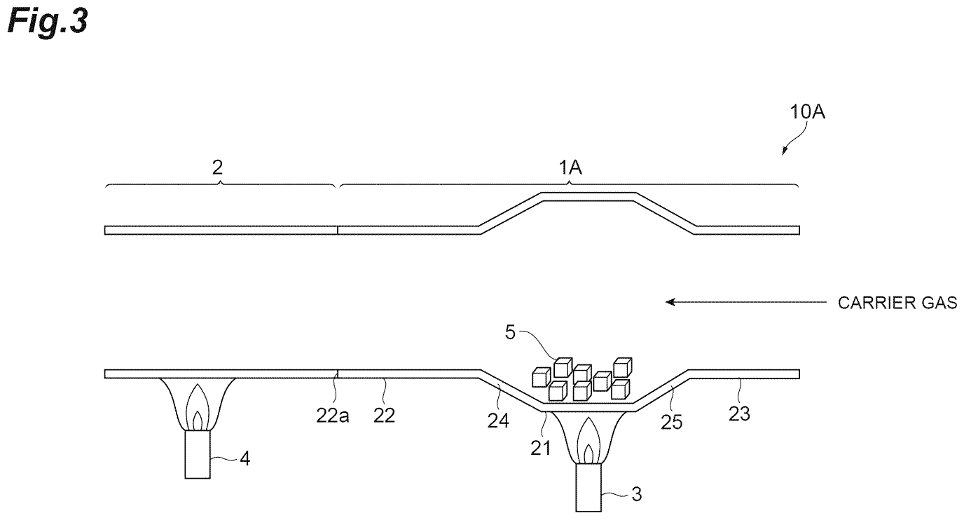

FIG. 3 is a view illustrating an addition process using an optical fiber producing device according to a modification example. An optical fiber producing device 10A according to the modification example is different from optical fiber producing device 10 in that a reservoir 1A is used instead of reservoir 1 (refer to FIG. 2). Reservoir 1A according to the modification example has a shape different from that of reservoir 1. Reservoir 1A has the same composition as that of reservoir 1. That is, reservoir 1A is formed from silica-based glass, and contains fluorine and chlorine. The sum of a fluorine concentration and a chlorine concentration in reservoir 1A is from 1500 ppm to 20000 ppm. The sum of the fluorine concentration and the chlorine concentration in reservoir 1A may be from 3500 ppm to 18000 ppm, or from 3500 ppm to 13000 ppm. The chlorine concentration in reservoir 1A is 20 ppm or more. The chlorine concentration in reservoir 1A may be 50 ppm or more.

Reservoir 1A includes a large-diameter portion 21, a first small-diameter portion 22, a second small-diameter portion 23, a first connecting portion 24, and a second connecting portion 25. In reservoir 1A, raw material 5 is installed mainly in large-diameter portion 21. An outer diameter of large-diameter portion 21 is larger than an outer diameter of glass pipe 2. The outer diameter of first small-diameter portion 22 and second small-diameter portion 23 are equal to the outer diameter of glass pipe 2, and is smaller than the outer diameter of large-diameter portion 21. First small-diameter portion 22 is connected to glass pipe 2.

First connecting portion 24 connects large-diameter portion 21 and the first small-diameter portion 22. As described above, since the outer diameter of first small-diameter portion 22 is smaller than the outer diameter of large-diameter portion 21, first connecting portion 24 forms a stepped portion. A height of the stepped portion by first connecting portion 24 is, for example, approximately 1 mm. First connecting portion 24 has a tapered shape. The outer diameter of first connecting portion 24 gradually decreases as going from large-diameter portion 21 to first small-diameter portion 22.

Second connecting portion 25 connects large-diameter portion 21 and second small-diameter portion 23. As described above, since the outer diameter of second small-diameter portion 23 is smaller than the outer diameter of large-diameter portion 21, second connecting portion 25 forms a stepped portion. A height of the stepped portion by second connecting portion 25 is, for example, approximately 1 mm. Second connecting portion 25 has a tapered shape. The outer diameter of second connecting portion 25 gradually decreases as going from large-diameter portion 21 to second small-diameter portion 23.

Reservoir 1A is formed from, for example, one glass pipe. A gas pressure inside the glass pipe is raised while heating a portion, which becomes large-diameter portion 21, in the one glass pipe, thereby increasing the diameter. According to this, reservoir 1A can be obtained. Reservoir 1A and glass pipe 2 are constituted by separate members. Reservoir 1A is integrated with glass pipe 2 by fusing and connecting first small-diameter portion 22 to glass pipe 2. First small-diameter portion 22 includes a connecting end 22a that is fused and connected to glass pipe 2.

Reservoir 1A and glass pipe 2 may have compositions different from each other and are not limited to the same composition even prior to addition process S2. In reservoir 1A, since first connecting portion 24 that forms a stepped portion on a side of large-diameter portion 21 close to glass pipe 2 exists, scattering of raw material 5 into glass pipe 2 due to the carrier gas is reduced. After addition process S2, reservoir 1A can be removed from glass pipe 2, and removed reservoir 1A can be used again in a state of being fused and connected to another glass pipe 2.

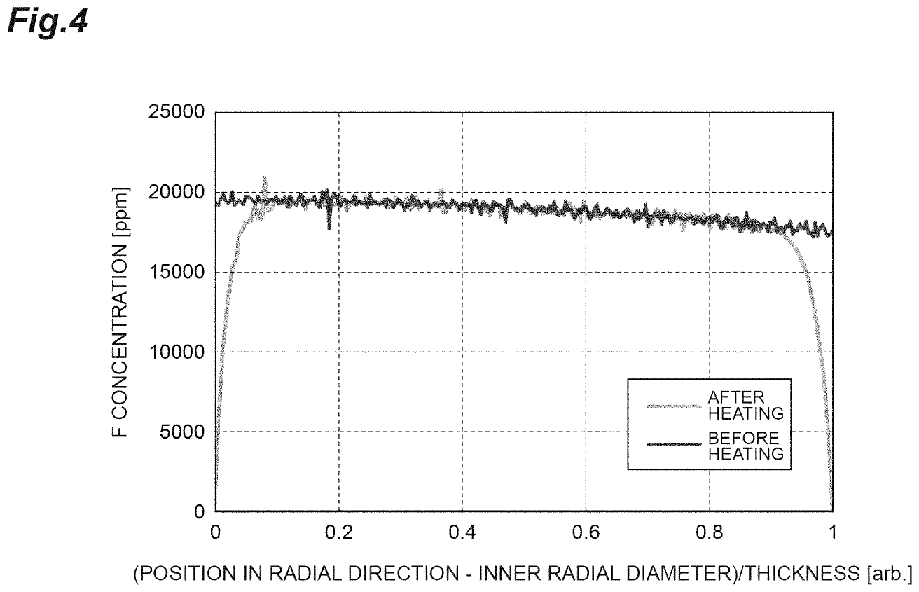

Hereinafter, the description will be given of evaluation results of a variation in a concentration distribution of added elements in accordance with heating when a reservoir is formed. FIG. 4 is a graph illustrating a variation in a concentration distribution of fluorine in accordance with heating when forming a reservoir. Here, reservoir 1A was used from the viewpoint of easy producing. A heating temperature during processing was set to from 1000° C. to 2000° C. When the heating temperature is set to the temperature range, viscosity of glass is lowered, and processability of glass is raised.

In FIG. 4, the vertical axis represents a fluorine concentration. The horizontal axis represents a value obtained by dividing a difference between a radial position from a central axis of the reservoir and an inner radius of the reservoir by the thickness of the reservoir. A position of 0 in the horizontal axis corresponds to an inner surface of the reservoir, and a position of 1 in the horizontal axis corresponds to an outer surface of the reservoir. As illustrated in FIG. 4, a fluorine concentration before heating is approximately 20000 ppm on the inner surface of the reservoir, gradually decreases as going toward an outer surface of the reservoir, and becomes approximately 17500 ppm on the outer surface of the reservoir.

In contrast, the fluorine concentration after heating becomes 0 on the inner surface and the outer surface of the reservoir. A rapid concentration variation occurs in the vicinity of the inner surface and in the vicinity of the outer surface in the reservoir. In this way, it can be confirmed that the fluorine concentration on the inner surface and the outer surface is reduced by heating the reservoir to a high temperature. Although not illustrated in the drawing, a variation in a concentration distribution of chlorine before and after heating was similar to the concentration distribution of fluorine.

Table 1 is a table showing a concentration of added elements of a glass material used in the evaluation and a defective rate of the reservoir. The added elements are chlorine (Cl), fluorine (F), and a hydroxyl group (OH) as a molecule that is easily doped with impurities. In Table 1, the sum of the chlorine concentration and the fluorine concentration is shown as a halogen concentration. The defective rate (manufacturing defective rate) of the reservoir represents probability of forming a reservoir that cannot be used for adding the alkali metal group when manufacturing the reservoir 20 times by heating with respect to respective concentration conditions.

TABLE 1

| | Cl | F | Halogen | OH | |
|---|---|---|---|---|---|
| | concen- | concen- | concen- | concen- | Defective |
| | tration | tration | tration | tration | rate |
| | [ppm] | [ppm] | [ppm] | [ppm] | [%] |
| Condition 1 | 8860 | 15807 | 24667 | Less than 1 | 40 |
| Condition 2 | 6 | 18968 | 18974 | Less than 1 | 20 |
| Condition 3 | 12 | 14226 | 14238 | Less than 1 | 10 |
| Condition 4 | 8860 | 6323 | 15183 | Less than 1 | 0 |
| Condition 5 | 2953 | 9484 | 12438 | Less than 1 | 0 |
| Condition 6 | 30 | 6323 | 6352 | Less than 1 | 0 |
| Condition 7 | 5907 | 9 | 5916 | Less than 1 | 0 |
| Condition 8 | 12 | 1581 | 1593 | Less than 1 | 15 |
| Condition 9 | 3544 | 32 | 3576 | Less than 1 | 0 |
| Condition 10 | 295 | 155 | 450 | Less than 1 | 30 |

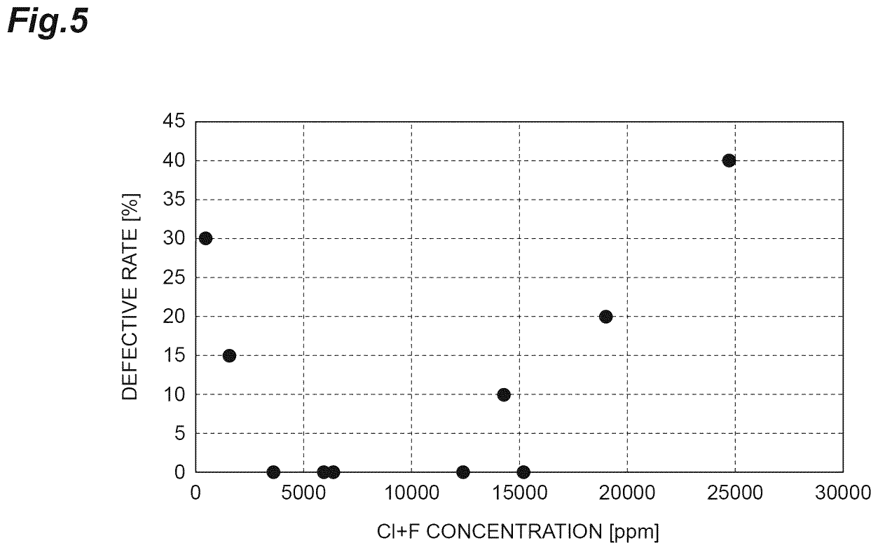

FIG. 5 is a graph illustrating a relationship between a halogen concentration and the defective rate of the reservoir. In FIG. 5, the vertical axis represents the defective rate of the reservoir, and the horizontal axis represents the halogen concentration, that is, the sum of the fluorine concentration and the chlorine concentration. In a region where the halogen concentration is high, the defective rate of the reservoir has increased. This is estimated because cracks caused by a rapid concentration difference in the vicinity of the surface of the reservoir occurred as illustrated in FIG. 4. In a region where the halogen concentration is low, the reservoir was defective due to poor shape control rather than cracks. This is estimated because the viscosity of glass as a whole was raised and processability deteriorated due to a large decrease in an addition concentration.

From the results in FIG. 5, it can be confirmed that the halogen concentration in the reservoir may be from 1500 ppm to 20000 ppm, from 3500 ppm to 18000 ppm, or from 3500 ppm to 13000 ppm.

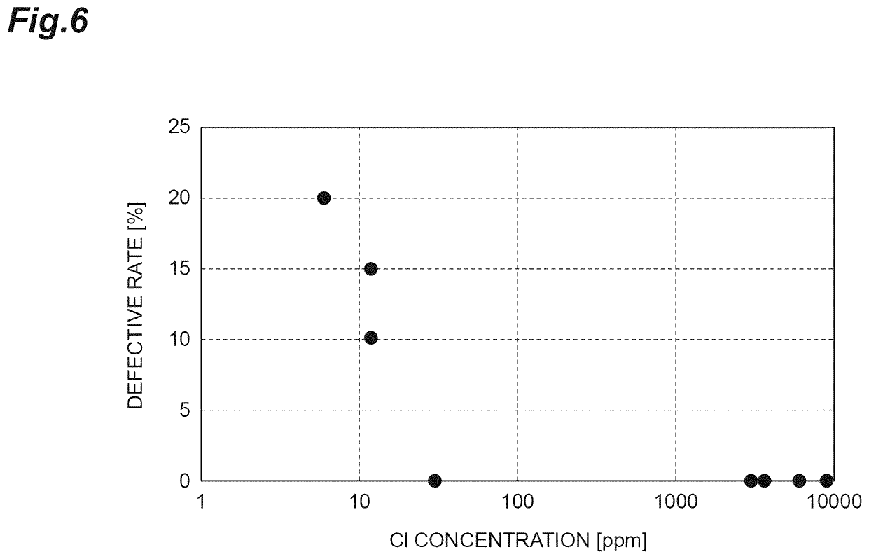

FIG. 6 is a graph illustrating a relationship between the chlorine concentration and the defective rate of the reservoir. In FIG. 6, the vertical axis represents the defective rate of the reservoir, and the horizontal axis represents the chlorine concentration. FIG. 6 shows results for Condition 2 to Condition 9 except for Condition 1 and Condition 10 with high defective rate. From results in FIG. 6, it can be confirmed that the defective rate increases even in a case where the chlorine concentration is low, and thus the chlorine concentration may be from 20 ppm or more, or 50 ppm or more. Under conditions in which the halogen concentration is within a certain range, a decrease in chlorine leads to an increase in a ratio of fluorine. Since fluorine has a large viscosity fluctuation effect and a large thermal expansion coefficient variation as compared with chlorine, when the ratio of fluorine increases, it is estimated that the viscosity fluctuation effect and the thermal expansion coefficient variation due to desorption of the halogen element on the surface are further promoted, and thus a tensile stress increases and a defect caused by cracks increases.

Hereinbefore, description has been given of the embodiment, but the present disclosure is not limited to the embodiment and the modification example, and various modifications can be made within a range not departing from the gist.

Reservoir 1 and glass pipe 2 may be constituted by separate members, and may be fused and connected to each other. Reservoir 1A and glass pipe 2 may be configured as one member.

### REFERENCE SIGNS LIST

1, 1A: reservoir, 2: glass pipe, 3, 4: heat source, 5: raw material, 10, 10A: producing device, 11: large-diameter portion, 12: small-diameter portion, 13: first connecting portion, 14: second connecting portion, 21: large-diameter portion, 22: first small-diameter portion, 22a: connecting end, 23: second small-diameter portion, 24: first connecting portion, 25: second connecting portion.

What is claimed is:

1. A reservoir which is used in producing an optical fiber preform and in which a raw material containing an alkali metal element or an alkaline-earth metal element is installed when adding the alkali metal element or the alkaline-earth metal element to a glass pipe formed from silica-based glass by thermal diffusion,
wherein the reservoir is formed from silica-based glass in which sum of a fluorine concentration and a chlorine concentration is from 1500 ppm to 20000 ppm.

2. The reservoir according to claim 1,
wherein the reservoir is formed from silica-based glass in which the sum of the fluorine concentration and the chlorine concentration is from 3500 ppm to 18000 ppm.

3. The reservoir according to claim 1,
wherein the reservoir is formed from silica-based glass in which the sum of the fluorine concentration and the chlorine concentration is from 3500 ppm to 13000 ppm.

4. The reservoir according to claim 1,
wherein the reservoir is formed from silica-based glass in which the chlorine concentration is 20 ppm or more.

5. The reservoir according to claim 1,
wherein the reservoir is formed from silica-based glass in which the chlorine concentration is 50 ppm or more.

6. The reservoir according to claim 1,
wherein the reservoir includes a connecting end that is separate from the glass pipe, and is fused and connected to the glass pipe.

7. A method for producing an optical fiber, comprising:
adding an alkali metal element or an alkaline-earth metal element to an inner surface of a glass pipe formed from silica-based glass by using the reservoir according to claim 1.

8. A device for producing an optical fiber, comprising:
the reservoir according to claim 1 which is connected to the glass pipe; and
a heat source configured to heat the reservoir,
wherein an alkali metal element or an alkaline-earth metal element is added to an inner surface of the glass pipe.
